(19) United States
(12) Patent Application Publication
(10) Pub. No.: US 2015/0158163 A1
(43) Pub. Date: Jun. 11, 2015

(54) NAIL PULLER

(71) Applicant: Yung-Shou Chen, Taichung (TW)

(72) Inventor: Yung-Shou Chen, Taichung (TW)

(21) Appl. No.: 14/097,626

(22) Filed: Dec. 5, 2013

(51) Int. Cl. B25C 11/00

(52) U.S. Cl. CPC B25C 11/00

(57) ABSTRACT

A nail puller includes a nail puller body having a mounting hole at its one end, and a stepped hollow cylindrical punching component removably fastened to the mounting hole of the nail puller body and having a step-like head and a stub tube-like punching tip respectively located at the two opposite ends thereof and respectively protruding outside the two opposite lateral sides of the nail puller body. The punching component of the nail puller can be struck by a hammer against a wood material around the nail head of the nail to be pulled, causing an annular dent to be formed in the wood material around the nail. At this time, a claw at one end of the nail puller body or the claw of a claw hammer can be inserted into the annular dent and then biased to extract the nail from the wood material.

### BACKGROUND OF THE INVENTION

(a) Field of the Invention

The present invention relates to nail pulling tools and more particularly to a nail puller that is equipped with a punching component for punching to assist nail extracting.

(b) Description of the Prior Art

Conventional nail pullers commonly comprise a nail puller body and a claw at one end or each of the two opposite ends of the nail puller body for extracting nails from some other object. FIGS. 11 and 12 illustrate a nail puller 1′ according to the prior art. According to this design, the nail puller 1′ has an integrated stub tube-like punching tip 11′ perpendicularly located at one side of one end thereof, and a hole 12′ located at an opposite side of the same end opposite to the stub tube-like punching tip 11′. The stub tube-like punching tip 11′ is adapted to assist nail extracting. When extracting a nail from a wood material, one attaches the stub tube-like punching tip 11′ onto the nail head of the nail to be extracted, and then operates a hammer 6 to strike the surface area around the hole 12′ of the nail puller 1′, forcing the stub tube-like punching tip 11′ against the wood material and causing formation of an annular dent in the wood material around the nail. When striking the hammer 6 against the surface area around the hole 12′ of the nail puller 1′, the applied forced can be distributed in different directions but not concentrated on a particular point, resulting in formation of an incomplete dent. Thus, the claw cannot be positively inserted into the incomplete dent and forced into engagement with the nail head to effectively assist nail extracting.

### SUMMARY OF THE INVENTION

The present invention has been accomplished under the circumstances in view. It is therefore the main object of the present invention to provide a nail puller, which comprises a nail puller body having a mounting hole located at one end thereof, and a punching component being a stepped hollow cylindrical member tightly fastened to the mounting hole of the nail puller body. The punching component comprises a step-like head located at one end thereof and protruding outside one lateral side of the nail puller body, and a stub tube-like punching tip located at an opposite end thereof and protruding outside an opposite lateral side of the nail puller body. Because the step-like head protrudes outside of the nail puller body, the step-like head of the punching component can be accurately struck by a hammer or like tool against a wood material. The punching component of the nail puller can be used to assist nail extracting. During application, the stub tube-like punching tip of the punching component is attached onto the nail head of the nail to be pulled, and then a hammer is operated to strike the head of the punching component against the wood material around the nail head of the nail to be pulled, causing formation of an annular dent in the wood material around the nail. At this time, a claw at one end of the nail puller body or the claw of a claw hammer can be inserted into the annular dent and then biased to extract the nail from the wood material.

In one embodiment of the present invention, the punching component can be fastened to the mounting hole of the nail puller body by press-fit connection.

In another embodiment of the present invention, the mounting hole of the nail puller body can be a screw hole having an inner thread therein; the punching component further comprises an outer thread extending around the periphery thereof and threaded into the inner thread in the mounting hole of the nail puller body.

Further, the step-like head of the punching component may be made in the form of a bolt head that can be a hex socket nut or hex nut.

### BRIEF DESCRIPTION OF THE DRAWINGS

FIG. 1 is an exploded view of a nail puller in accordance with a first embodiment of the present invention.

FIG. 2 is a top elevational view of the nail puller in accordance with the first embodiment of the present invention.

FIG. 3 is a top plan view of the nail puller in accordance with the first embodiment of the present invention.

FIG. 4 is a sectional view taken along line A-A of FIG. 3.

FIG. 5 is a schematic drawing illustrating a punching operation of the nail puller in accordance with the first embodiment of the present invention (I).

FIG. 6 is a schematic drawing illustrating a punching operation of the nail puller in accordance with the first embodiment of the present invention (II).

FIG. 7 is a schematic drawing illustrating a punching operation of the nail puller in accordance with the first embodiment of the present invention (III).

FIG. 8 is a schematic drawing illustrating the nail extracting operation of the nail puller after formation of the annular dent in the wood material around the nail.

FIG. 9 is a schematic sectional assembly view of a nail puller in accordance with a second embodiment of the present invention.

FIG. 10 is an exploded view of a nail puller in accordance with a third embodiment of the present invention.

FIG. 11 is an oblique top elevational view of a nail puller according to the prior art.

FIG. 12 is a schematic drawing illustrating a punching application of the prior art nail puller.

### DETAILED DESCRIPTION OF THE PREFERRED EMBODIMENTS

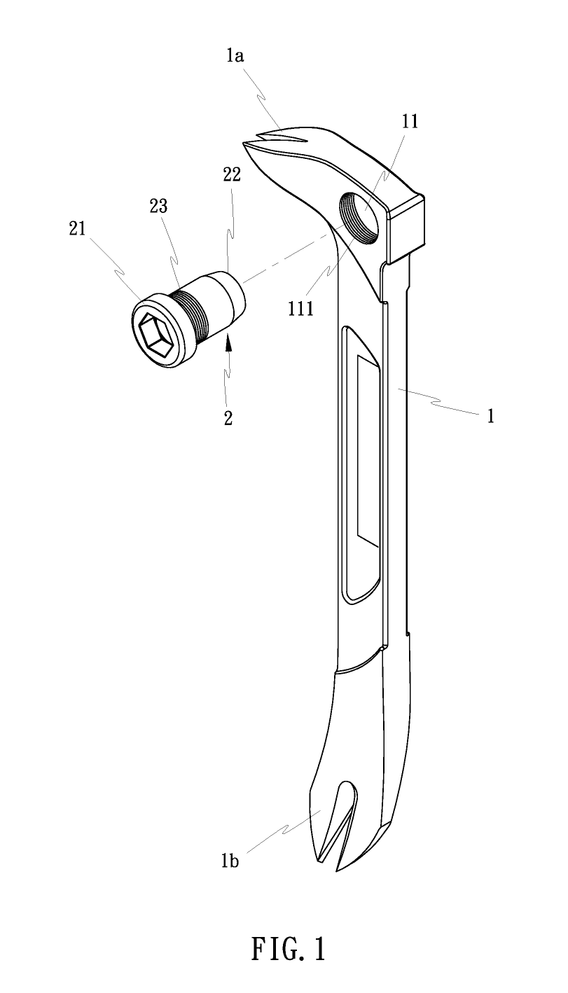

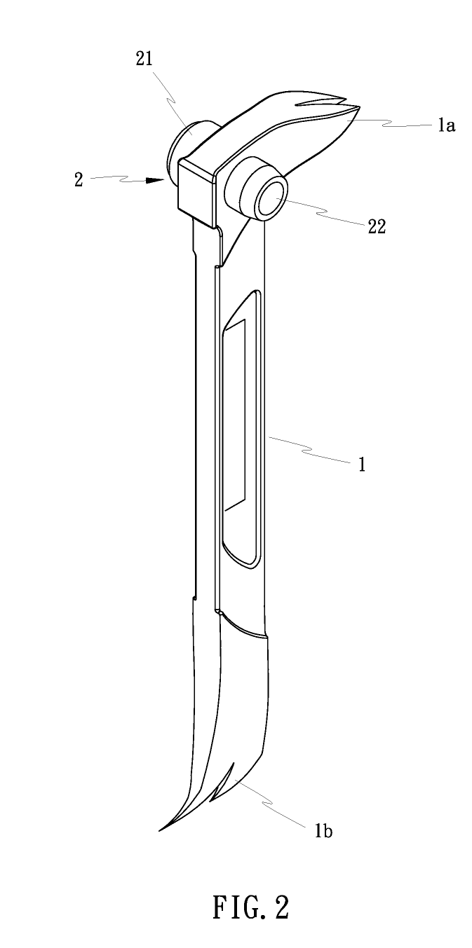

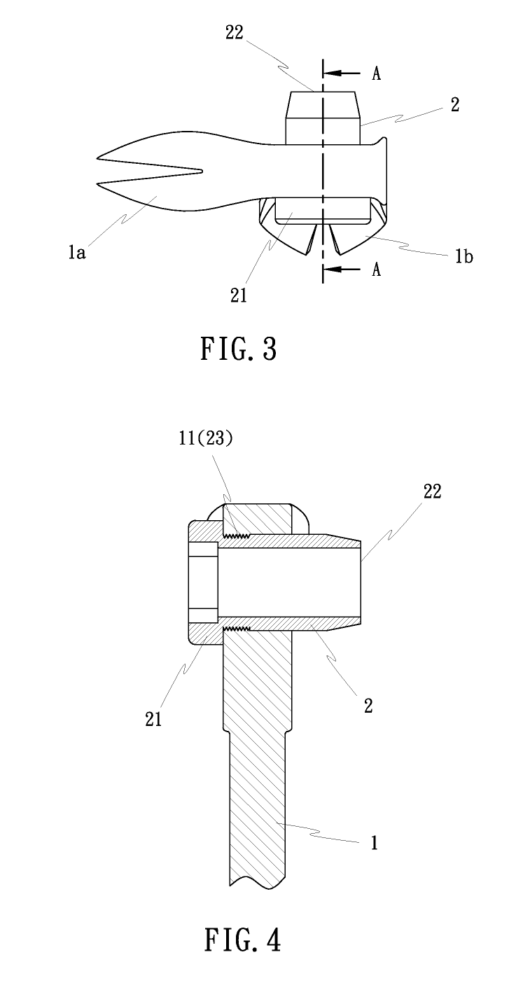

Referring to FIGS. 1-5, a nail puller in accordance with a first embodiment of the present invention is shown. In this embodiment, the nail puller comprises a nail puller body 1, and a punching component 2.

The nail puller body 1 has a mounting hole 11 at one end thereof. In this embodiment, the mounting hole 11 is a screw hole having an inner thread 111.

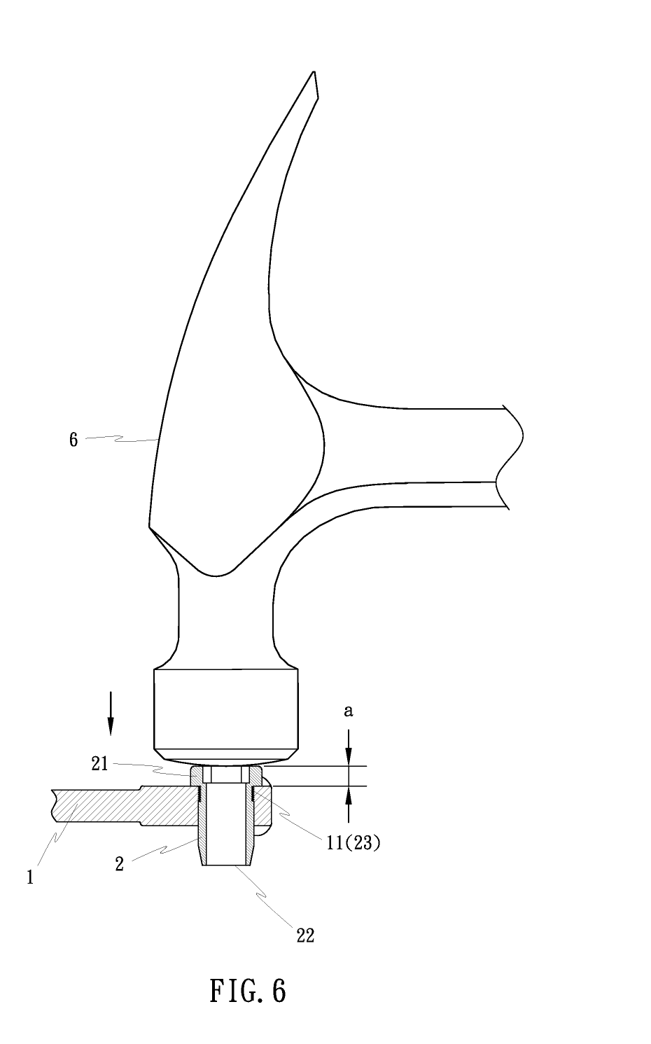

The punching component 2 is a stepped hollow cylindrical member having a step-like head 21 located at one end thereof, a stub tube-like punching tip 22 located at an opposite end thereof, and an outer thread 23 spirally extending around the periphery thereof adjacent to the step-like head 21. The punching component 2 is fastened to the nail puller body 1 by threading the outer thread 23 into the inner thread 111 in the mounting hole 11. After threading of the outer thread 23 into the inner thread 111 in the mounting hole 11, the nail puller body 1 and the punching component 2 are firmly secured together, and the head 21 and stub tube-like punching tip 22 of the punching component 2 are respectively held outside two opposite lateral sides of the nail puller body 1. As shown in FIG. 6, the head 21 protrudes outside one lateral side of the nail puller body 1 by a predetermined height “a”. Further, the step-like head 21 of the punching component 2 in this embodiment is made in the shape of a bolt head. The bolt head can be in the form of a hex socket nut (as illustrated).

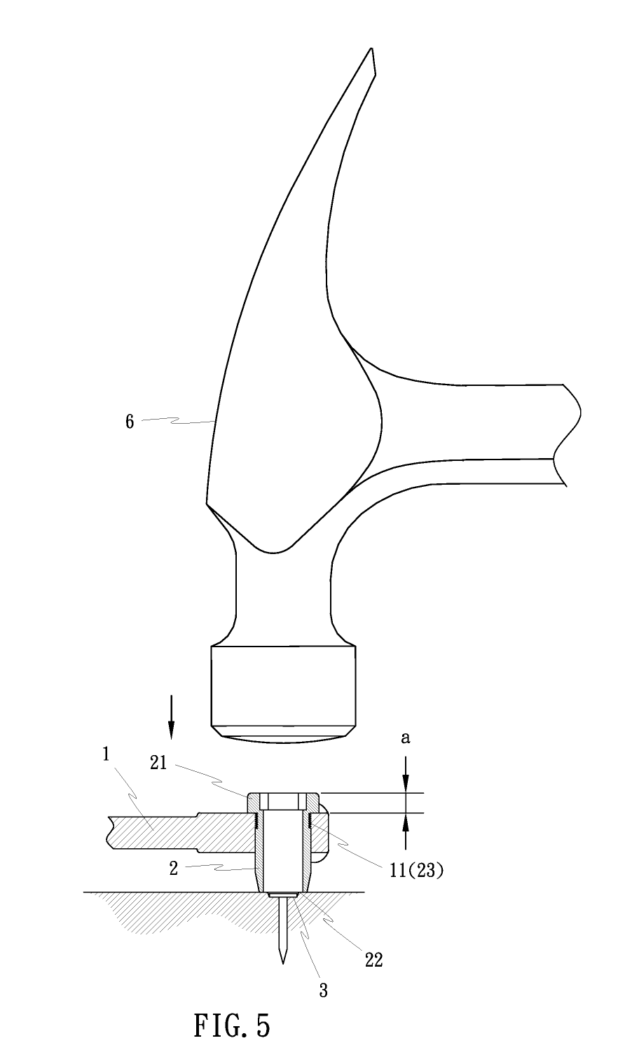

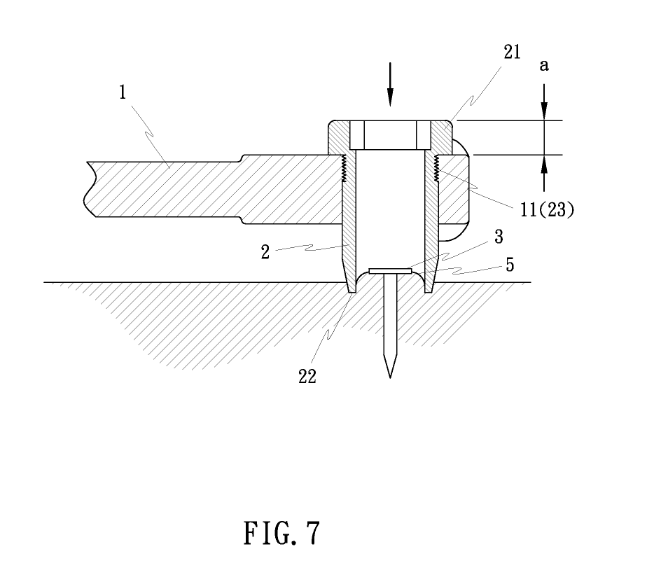

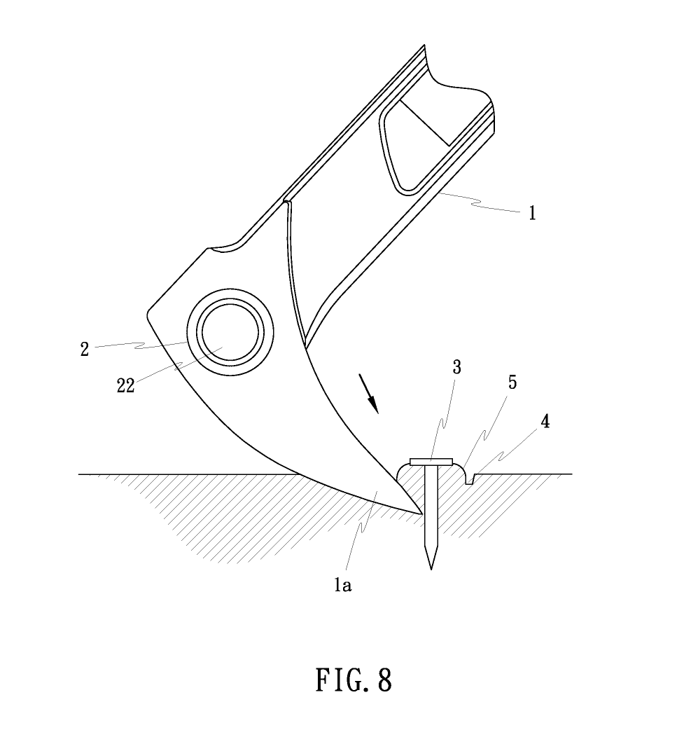

The nail puller formed of the aforesaid nail puller body 1 and punching component 2 can be used to assist nail extracting. In this case, attach the stub tube-like punching tip 22 of the punching component 2 onto the nail head 3, and then use a hammer 6 to strike the head 21 of the punching component 2 against the wood material 5 around the nail head 3 (see FIGS. 5-7), causing an annular dent 4 to be formed in the wood material 5 around the nail head 3 (see FIG. 8). After the annular dent 4 is formed in the wood material 5 around the nail head 3, insert the claw 1a or 1b at one end of the nail puller body 1 into the annular dent 4 and then bias the nail puller body 1 to pull the nail out of the wood material 5.

In this embodiment, two claws 1a and 1b are respectively provided at the two opposite ends of the nail puller body 1. Alternatively, the nail puller body 1 can be configured to provide only one claw at its one end, or to provide a claw at its one end and another tool, for example, a peen at its other end.

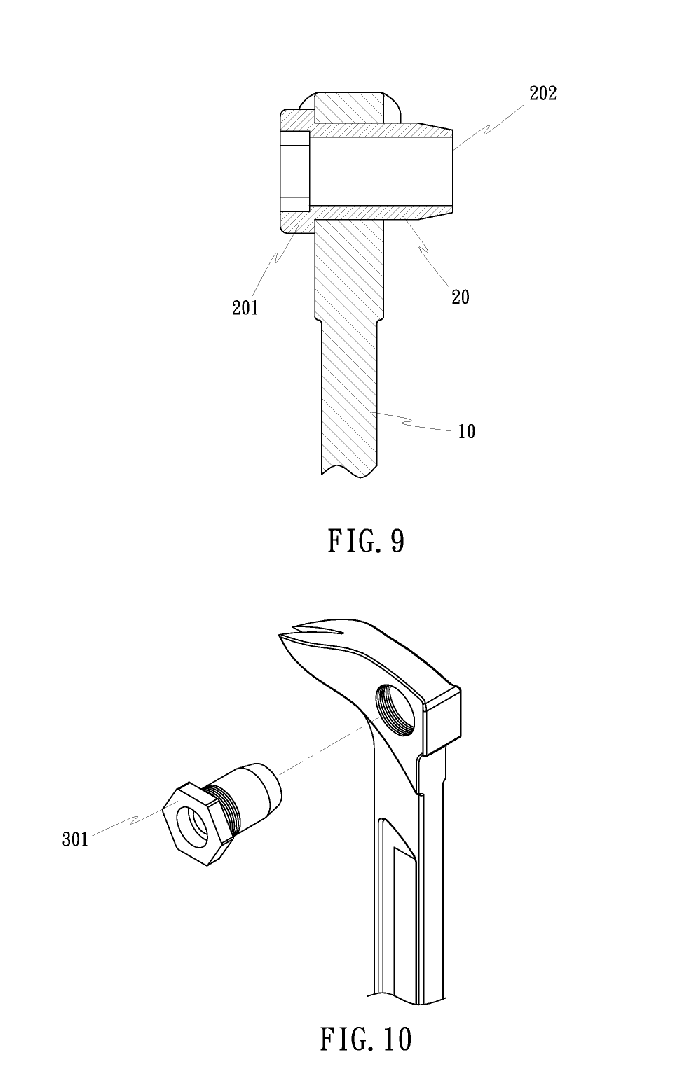

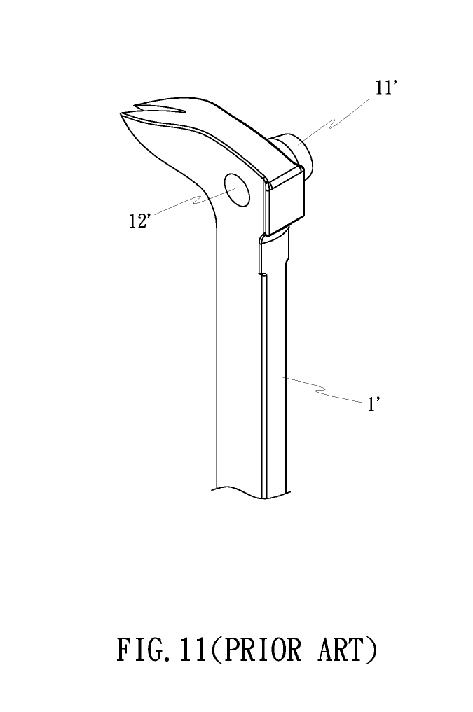

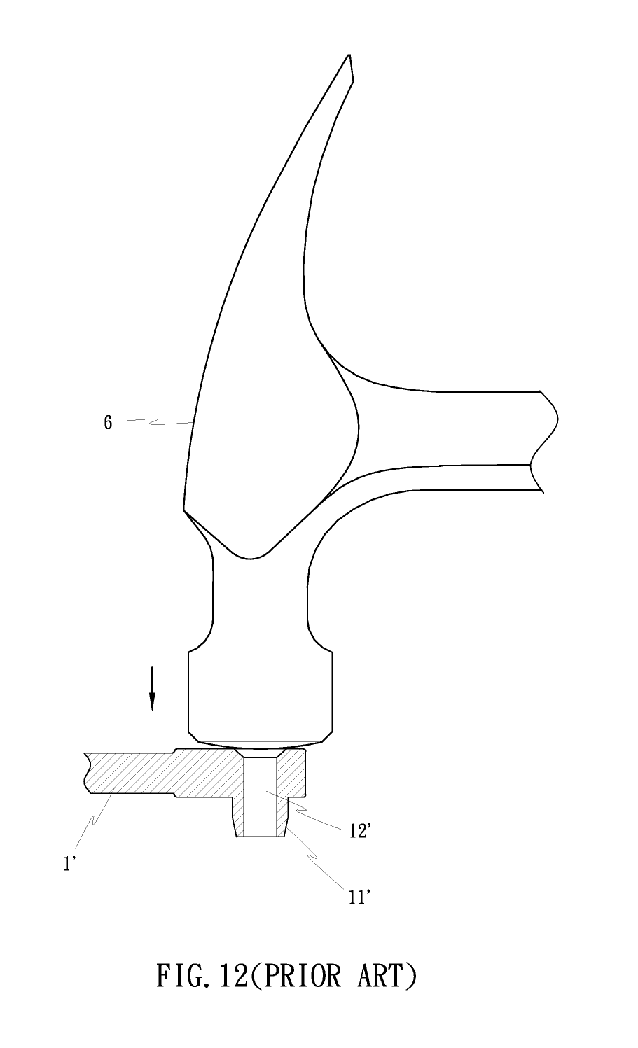

In the aforesaid first embodiment, the nail puller body 1 and the punching component 2 are fastened together by means of screw connection. Alternatively, a press-fit connection using a dimensional tolerance can be employed. In a second embodiment of the present invention, as illustrated in FIG. 9, there is a dimensional tolerance between the mounting hole of the nail puller body 10 and the outer diameter of the punching component 20. Thus, the punching component 20 can be press-fitted into the mounting hole of the nail puller body 10, holding the head 201 and stub tube-like punching tip 202 of the punching component 20 outside the two opposite lateral sides of the nail puller body 10.

Further, except the bolt head configuration described in the first embodiment of the present invention, the step-like head of the punching component can be made in a simple protrusion convenient for striking by a peen to produce the effect of concentrated force. Further, the step-like head is not limited to the configuration of hex socket nut. In a third embodiment of the present invention, as shown in FIG. 10, the step-like head 301 is made in the form of a hex nut.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A nail puller, comprising:
a nail puller body having a mounting hole located at one end thereof; and
a punching component being a stepped hollow cylindrical member fastened to said mounting hole of said nail puller body, said punching component comprising a step-like head located at one end thereof and protruding outside one lateral side of said nail puller body and a stub tube-like punching tip located at an opposite end thereof and protruding outside an opposite lateral side of said nail puller body.

2. The nail puller as claimed in claim 1, wherein said mounting hole of said nail puller body comprises an inner thread; said punching component further comprises an outer thread extending around the periphery thereof and threaded into said inner thread in said mounting hole of said nail puller body.

3. The nail puller as claimed in claim 1, wherein said step-like head of said punching component is made in the form of a bolt head.

4. The nail puller as claimed in claim 3, wherein said bolt head exhibits the shape of a hex socket nut.

5. The nail puller as claimed in claim 3, wherein said bolt head exhibits the shape of a hex nut.

6. The nail puller as claimed in claim 1, wherein said nail puller body further comprises a claw at at least one of two opposite ends thereof.

7. The nail puller as claimed in claim 1, wherein said punching component is removably fastened to said mounting hole of said nail puller body by a press-fit connection.
